(19) United States
(12) Patent Application Publication
(10) Pub. No.: US 2012/0023152 A1
(43) Pub. Date: Jan. 26, 2012

(54) Methods and Systems for Providing Location-Based Interactive Golf Content for Display by a Mobile Device

(75) Inventors: Michelle Felt, Randolph, NJ (US); John F. Gallagher, Hopewell, NJ (US); Donald H. Relyea, Dallas, TX (US); Farida Saeed, Boonton, NJ (US)

(73) Assignee: VERIZON PATENT AND LICENSING, INC., Basking Ridge, NJ (US)

(21) Appl. No.: 12/839,875

(22) Filed: Jul. 20, 2010

(51) Int. Cl. G06F 15/16

(52) U.S. Cl. 709/203

(57) ABSTRACT

An exemplary method includes an interactive golf content computing system detecting a geographic location of a mobile device associated with a golfer while the golfer is playing a golf hole, selecting interactive golf content associated with one or more other golfers who played the golf hole previous to the playing of the golf hole by the golfer in accordance with the detected geographic location, and providing the selected interactive golf content for display by the mobile device. Corresponding methods and systems are also described.

### BACKGROUND INFORMATION

The use of technology on the golf course has proliferated in recent years as global positioning satellite (“GPS”) and mobile device technology have become more accessible to the general population. For example, various golf applications have been designed to run on GPS-enabled smart phones that may be used to calculate yardages and keep track of scores. However, currently available golf applications only provide content related to the golfer and one or more playing partners.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates a location-based interactive golf content computing system according to principles described herein.

FIG. 2 illustrates an exemplary implementation of the system of FIG. 1 according to principles described herein.

FIG. 3 illustrates another exemplary implementation of the system of FIG. 1 according to principles described herein.

FIG. 4 illustrates an exemplary method of providing location-based interactive golf content for display by a mobile device associated with a golfer according to principles described herein.

FIG. 5 illustrates an exemplary graphical user interface (“GUI”) that may be provided for display by a mobile device associated with a golfer according to principles described herein.

FIGS. 6-9 show various views of the GUI of FIG. 5 according to principles described herein.

FIG. 10 illustrates another exemplary method of providing location-based interactive golf content for display by a mobile device associated with a golfer according to principles described herein.

FIG. 11 illustrates an exemplary computing device according to principles described herein.

### DETAILED DESCRIPTION OF PREFERRED EMBODIMENTS

Methods and systems for providing location-based interactive golf content for display by a mobile device are described herein. As described in more detail below, an interactive golf content computing system may detect a geographic location of a mobile device associated with a golfer while the golfer is playing a golf hole, select interactive golf content associated with one or more other golfers who played the golf hole previous to the playing of the golf hole by the golfer in accordance with the detected geographic location, and provide the selected interactive golf content for display by the mobile device.

As used herein, “playing a golf hole” refers to any action taken by a golfer with respect to the golf hole. Hence, playing a golf hole may refer to preparing to take and/or taking one or more strokes (e.g., a tee shot, a fairway shot, a putt, and/or any other type of stroke) to put a golf ball in a hole, moving (e.g., walking and/or riding) between successive strokes, analyzing one or more strokes taken to put the golf ball in the hole, and/or any other action taken by a golfer with respect to the golf hole.

As used herein, “interactive golf content” refers to any interactive content associated with one or more golfers that may be provided for display by a mobile device associated with (e.g., carried by) a golfer. Interactive golf content may include one or more “interactive golf content instances.” Examples of interactive golf content instances include, but are not limited to, geotagged social networking content provided by one or more golfers (e.g., Twitter updates, blog posts, Facebook posts, etc.), scoring information associated with one or more golfers (e.g., number of strokes that one or more golfers take to complete a particular golf hole), multimedia content associated with one or more golfers (e.g., video content showing one or more golf shots taken by one or more golfers while playing a particular golf hole), lie information associated with one or more golfers (e.g., where one or more golfers hit their golf balls on a particular golf hole), golf club selection information associated with one or more golfers (e.g., which golf club one or more golfers used to hit one or more shots on a particular golf hole), a picture of one or more golfers (e.g., a photograph of one or more golfers who play a particular golf hole), and contact information associated with one or more golfers (e.g., selectable phone numbers, email addresses, etc. of one or more golfers who play a particular golf hole).

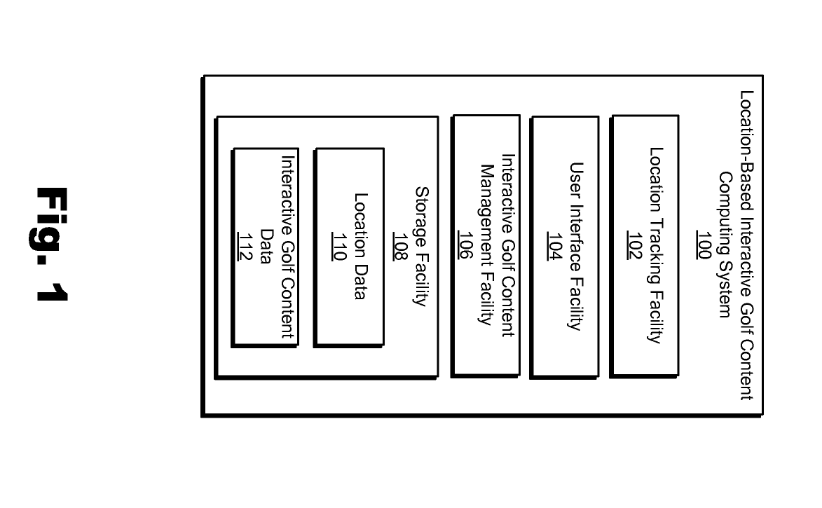

FIG. 1 illustrates a location-based interactive golf content computing system 100 (or simply “system 100”). As will be described in more detail below, system 100 may be configured to provide location-based interactive golf content for display by a mobile device associated with a golfer while the golfer is playing a golf hole at a golf course or at any other golf premises. The location-based interactive golf content may be associated with and/or provided by one or more other golfers who have played the golf hole previous to the playing of the golf hole by the golfer. System 100 may include, but is not limited to, a location tracking facility 102, a user interface facility 104, an interactive golf content management facility 106, and a storage facility 108 selectively and communicatively coupled to one another. Each of these facilities will now be described in more detail.

Location tracking facility 102 may be configured to track (e.g., detect) a geographic location of a mobile device associated with a golfer. The tracking of the geographic location of the mobile device may be performed in any suitable way and using any suitable technologies, including, without limitation, Global Positioning System (“GPS”) technologies and terrestrial signaling triangulation technologies. As an example, a mobile device may include a mobile phone carried by the golfer, the location of which may be tracked using GPS and/or cellular phone wireless signaling triangulation technologies. In certain embodiments, location tracking facility 102 may track the geographic location of a mobile device relative to (e.g., within) a particular geographic space (e.g., within a golf course premises). One or more wireless signaling transmitters may be employed to boost reception of location tracking signals within the geographic space.

In some examples, location tracking facility 102 may be configured to detect an exact location (e.g., latitude and longitude coordinates) of a mobile device. Alternatively, location tracking facility 102 may be configured to detect an approximate location (e.g., by way of triangulation) of the mobile device.

In some examples, location tracking facility 102 may track a geographic location of a mobile device associated with a golfer while the golfer is playing a golf hole. In this manner, as will be described in more detail below, interactive golf content may be selected for display by the mobile device in accordance with one or more detected geographic locations of the mobile device (and, consequently, the golfer).

User interface facility 104 may be configured to provide one or more user interfaces configured to facilitate interaction by a golfer with system 100. For example, user interface facility 104 may provide a user interface for display by a mobile device associated with (e.g., carried by) a golfer through which one or more functions, options, features, and/or tools may be provided to a golfer and through which input provided by the golfer may be received. In certain embodiments, user interface facility 104 may be configured to direct a mobile device to display one or more graphical user interfaces (“GUIs”), interactive golf content, and/or any other content as may serve a particular implementation.

Interactive golf content management facility 106 may be configured to manage (e.g., create, maintain, update, select, etc.) interactive golf content associated with one or more golfers. For example, interactive golf content management facility 106 may manage one or more interactive golf content instances associated with one or more golfers.

In some examples, in response to a detection by location tracking facility 102 of a geographic location of a mobile device associated with a golfer while the golfer is playing a golf hole, interactive golf content management facility 106 may select interactive golf content associated with one or more other golfers who played the golf hole previous to the playing of the golf hole by the golfer. As will be described in more detail below, the selection of the interactive golf content may be performed in accordance with the detected geographic location. Interactive golf content management facility 106 may then provide the selected interactive golf content for display by the mobile device. For example, interactive golf content management facility 106 may provide the selected interactive golf content for display within one or more GUIs provided by user interface facility 104.

Interactive golf content management facility 106 may additionally or alternatively be configured to geotag one or more interactive golf content instances provided by a golfer while the golfer is playing a golf hole. For example, a first golfer may post a Twitter update after hitting a particular shot. A geographic location of the mobile device at the time of posting of the Twitter update may be detected and associated with the Twitter update as a geotagged location of the Twitter update. As will be described in more detail below, the geotagged location may be compared to a detected geographic location of a mobile device of a second golfer playing the golf hole and used to determine whether the Twitter update should be included in interactive golf content selected for display by the mobile device of the second golfer.

Interactive golf content management facility 106 may additionally or alternatively be configured to timestamp one or more interactive golf content instances provided by a golfer while the golfer is playing a golf hole. The timestamps may be used to determine whether the one or more interactive golf content instances should be included in interactive golf content selected for display by a mobile device of one or more other golfers playing the golf hole. For example, a golfer may direct system 100 to only provide interactive golf content instances having timestamps within a predetermined timeframe for display by a mobile device associated with the golfer.

Interactive golf content management facility 106 may select interactive golf content for display by a mobile device in any suitable manner as may serve a particular implementation. For example, interactive golf content management facility 106 may analyze a geotagged location corresponding to each of a plurality of interactive golf content instances and select, based on the analysis, one or more of the plurality of interactive golf content instances having a corresponding geotagged location located within a predetermined distance of the detected geographic location of the mobile device to be included in the interactive golf content selected for display by the mobile device. Additionally or alternatively, interactive golf content management facility 106 may select an interactive golf content instance for display by the mobile device based on an identity of a golfer associated with the interactive golf content instance, a particular stroke (e.g., a tee shot) associated with the interactive golf content instance, a particular golf hole associated with the interactive golf content instance, and/or in accordance with any other factor deemed relevant by interactive golf content management facility 106.

In some examples, interactive golf content management facility 106 may designate a relative display size of each of a plurality of interactive golf content instances displayed by a mobile device based on a relative proximity of a geotagged location of each of the interactive golf content instances to a detected geographic location of the mobile device. For example, the plurality of interactive golf content instances may include a first interactive golf content instance having a first geotagged location and a second interactive golf content instance having a second geotagged location relatively farther away from the detected geographic location of the mobile device than the first geotagged location. Interactive golf content management facility 106 may designate the first interactive golf content instance to have a larger display size than the second interactive golf content instance in a GUI because the geotagged location of the first interactive golf content instance is relatively closer to the detected geographic location of the mobile device.

In some examples, interactive golf content management facility 106 may select updated interactive golf content for display by a mobile device associated with a golfer in response to a detection by location tracking facility 102 of an updated geographic location of the mobile device. For example, location tracking facility 102 may detect a movement by a golfer to another position while playing a golf hole (e.g., walking or riding from a first shot location to a second shot location). Interactive golf content management facility 106 may select updated interactive golf content in accordance with the updated geographic location and provide the selected updated interactive golf content for display by the mobile device.

In some examples, interactive golf content management facility 106 may determine that the golfer has finished playing a golf hole and moved on to playing a new golf hole. The determination may be made in response to input provided by the golfer and/or in any other manner as may serve a particular implementation. In response to the determination, interactive golf content management facility 106 may select new interactive golf content associated with the new golf hole for display by the mobile device in accordance with a detected geographic location of the mobile device while the golfer is playing the new golf hole.

In some examples, interactive golf content management facility 106 may provide weather information associated with a detected geographic location of a mobile device associated with a golfer for display by the mobile device. The weather information may include, but is not limited to, wind information, temperature information, precipitation information, and/or any other type of weather information as may serve a particular implementation. The weather information may be generated and/or acquired in any suitable manner as may serve a particular implementation.

In some examples, interactive golf content management facility 106 may automatically generate advice for the golfer based on selected interactive golf content. The advice may be provided for presentation by the mobile device. For example, the mobile device may display and/or audibly present the advice. The advice may include any type of advice relevant to playing the golf hole. For example, the advice may include golf club selection advice based on a golf club selection made by one or more other golfers who played the golf hole, aiming advice, hazard warning advice, and/or any other advice as may serve a particular implementation.

In some examples, interactive golf content management facility 106 may facilitate input by a golfer of interactive golf content associated with the golfer while the golfer is playing the golf hole. For example, interactive golf content management facility 106 may facilitate input by a golfer of social networking content, scoring content, golf club selection content, multimedia content, and/or any other interactive golf content as may serve a particular implementation. The interactive golf content input by the golfer may then be provided for display by one or more other mobile devices associated with one or more other golfers playing the golf hole and/or by a mobile device associated with the golfer when the golfer plays the golf hole again at a future time. Alternatively, the golfer may elect to keep private the interactive golf content that he or she provides.

In some examples, interactive golf content management facility 106 may provide a map of a golf hole for display by a mobile device. As will be described in more detail below, interactive golf content may be configured to be overlaid on the map when displayed by the mobile device.

Storage facility 108 may be configured to maintain location data 110 representative of a geographic location of a mobile access device and a geotagged location of one or more interactive golf content instances and interactive golf content data 112 representative of one or more interactive golf content instances. It will be recognized that storage facility 108 may maintain additional or alternative data as may serve a particular implementation.

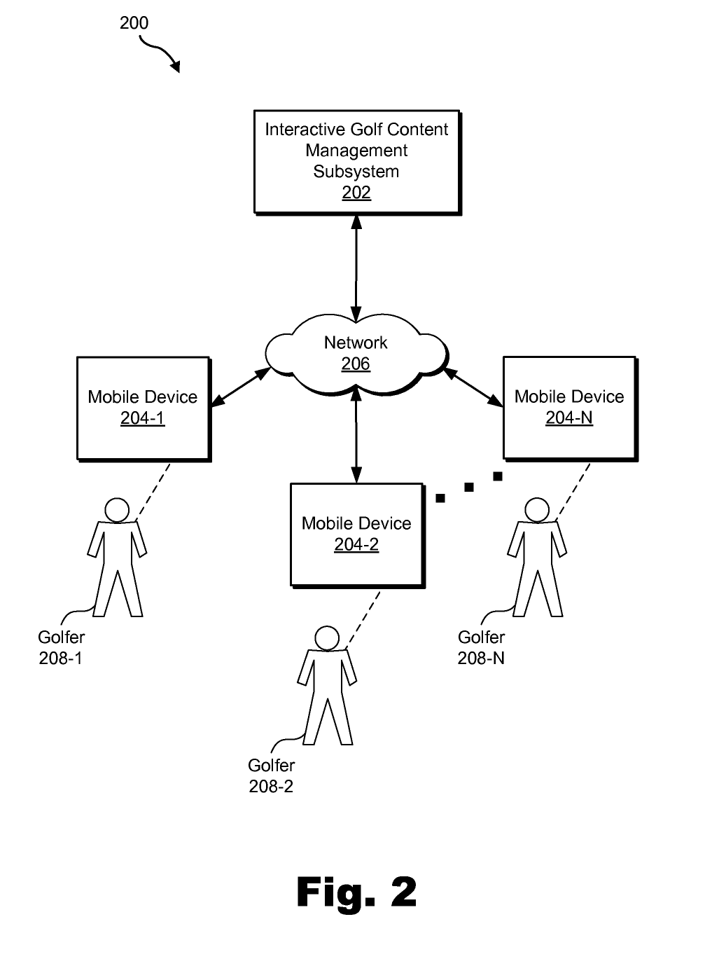

FIG. 2 illustrates an exemplary implementation 200 of system 100. As shown in FIG. 2, implementation 200 may include an interactive golf content management subsystem 202 selectively and communicatively coupled to a plurality of mobile devices 204 (e.g., mobile devices 204-1 through 204-N).

Mobile devices 204 and interactive golf content management subsystem 202 may communicate using any communication platforms and technologies suitable for transporting data and/or communication signals, including known communication technologies, devices, media, and protocols supportive of remote data communications, examples of which include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), Golfer Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, wireless communication technologies, in-band and out-of-band signaling technologies, and other suitable communications networks and technologies.

In certain embodiments, mobile devices 204 and interactive golf content management subsystem 202 may communicate via a network 206, which may include one or more networks, including, but not limited to, wireless networks (Wi-Fi networks), (e.g., wireless communication networks), mobile telephone networks (e.g., cellular telephone networks), closed media networks, open media networks, closed communication networks, open communication networks, satellite networks, navigation networks, broadband networks, narrowband networks, voice communication networks (e.g., VoIP networks), the Internet, and any other networks capable of carrying data and/or communications signals between mobile devices 204 and interactive golf content management subsystem 202. Communications between interactive golf content management subsystem 202 and mobile devices 204 may be transported using any one of above-listed networks, or any combination or sub-combination of the above-listed networks. In certain exemplary embodiments, network 206 includes a mobile telephone network.

Mobile devices 204 may be associated with a plurality of golfers 208 (e.g., golfers 208-1 through 208-N), which in certain embodiments may be subscribers to or end users of one or more services (e.g., a wireless telephone service) provided over network 206. Mobile devices 204 may each include any mobile device configured to perform one or more of the mobile device operations described herein, including communicating with interactive golf content management subsystem 202 by way of network 206. Each mobile device 204 may include, but is not limited to, a wireless computing device, a wireless communication device (e.g., a mobile phone configured to access one or more services provided over network 206), a portable computing device (e.g., a laptop computer, a tablet computer, etc.), a golf cart, a personal digital assistant, and/or any other mobile device configured to perform one or more of the mobile device operations described herein.

In certain embodiments, mobile devices 204 may be associated with heterogeneous communication platforms, and interactive golf content management subsystem 202 may be configured to communicate with each of the heterogeneous platforms. Accordingly, various types of mobile devices 204 associated with various communication platforms may be used by consumers to access one or more of the features and/or processes described herein.

In certain embodiments, system 100 may be implemented entirely by or within interactive golf content management subsystem 202. In other embodiments, components of system 100 may be distributed across interactive golf content management subsystem 202 and mobile devices 204. For example, a mobile device 204 may include a client (e.g., a client application) implementing one or more of the facilities of system 100.

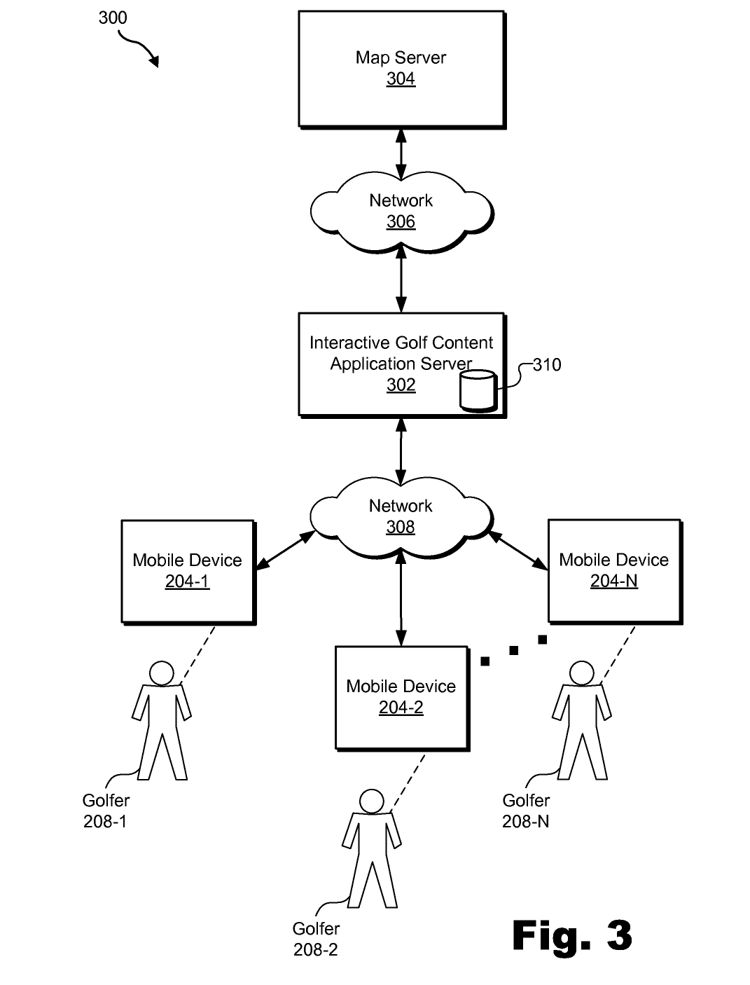

Interactive golf content management subsystem 202 may include one or more computing devices (e.g., one or more server devices) implementing one or more components of system 100. For example, FIG. 3 illustrates another exemplary implementation 300 of system 100 wherein interactive golf content management subsystem 202 is implemented by an interactive golf content application server 302 and a map server 304. Interactive golf content application server 302 and map server 304 may be configured to communicate by way of network 306, which may include any of the networks described herein.

Interactive golf content application server 302 may be configured to communicate with mobile devices 204 by way of network 308, which may include any of the networks described herein. Interactive golf content application server 302 may be further configured to host data utilized by an interactive golf content application residing within one or more of mobile devices 204 and/or perform any of the interactive golf content management functions described herein. For example, interactive golf content application server 302 may maintain a database 310 of interactive golf content instances that may be provided for display by one or more of mobile devices 204.

Map server 304 may be configured to maintain data representative of one or more maps of a golf course and/or specific golf holes within a golf course. Map server 304 may provide data representative of such maps for display by one or more mobile devices 204, as described above. The map data may be provided by way of interactive golf content server application server 302, as shown in FIG. 3. Alternatively, the map data may be provided directly to mobile devices 204.

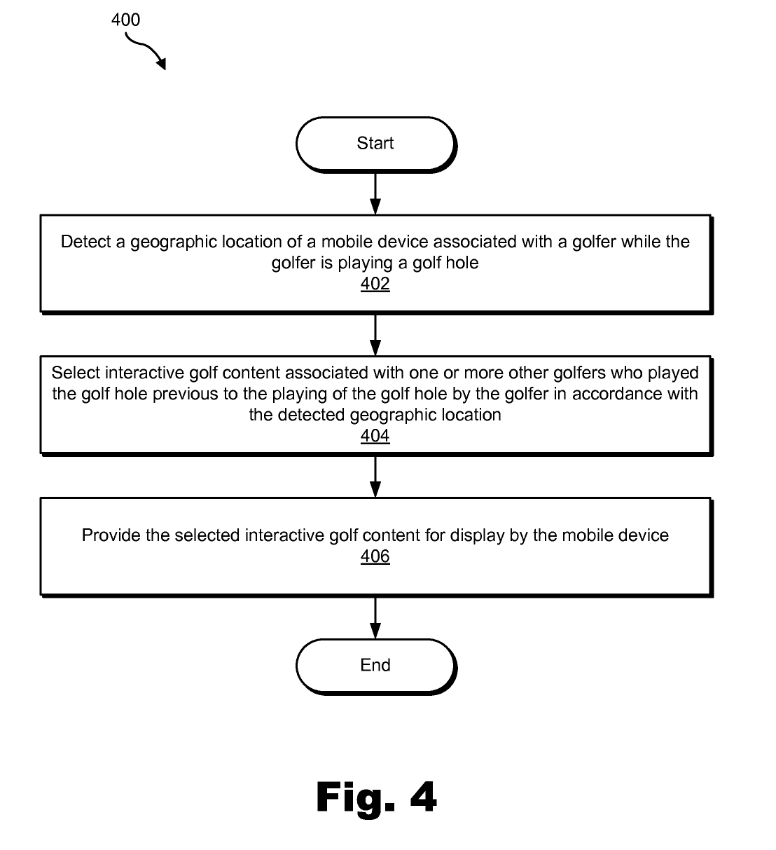

FIG. 4 illustrates an exemplary method 400 of providing location-based interactive golf content for display by a mobile device associated with a golfer. While FIG. 4 illustrates exemplary steps according to one embodiment, other embodiments may omit, add to, reorder, and/or modify any of the steps shown in FIG. 4. The steps shown in FIG. 4 may be performed by any component or combination of components of system 100, interactive golf content management subsystem 202, mobile device 204, and/or interactive golf content application server 302 as may serve a particular implementation.

In step 402, a geographic location of a mobile device associated with a golfer is detected while the golfer is playing a golf hole. The geographic location of the mobile device may be detected in any of the ways described herein.

In step 404, interactive golf content associated with one or more other golfers who played the golf hole previous to the playing of the golf hole by the golfer is selected in accordance with the detected geographic location. The interactive golf content associated with the one or more other golfers may be selected in any of the ways described herein.

In step 406, the selected interactive golf content is provided for display by the mobile device. The selected interactive golf content may be provided for display by the mobile device in any of the ways described herein.

Various examples that implement the method 400 of providing location-based interactive golf content for display by a mobile device associated with a golfer will now be presented. It will be recognized that the examples presented herein are merely illustrative of the many different implementations of method 400.

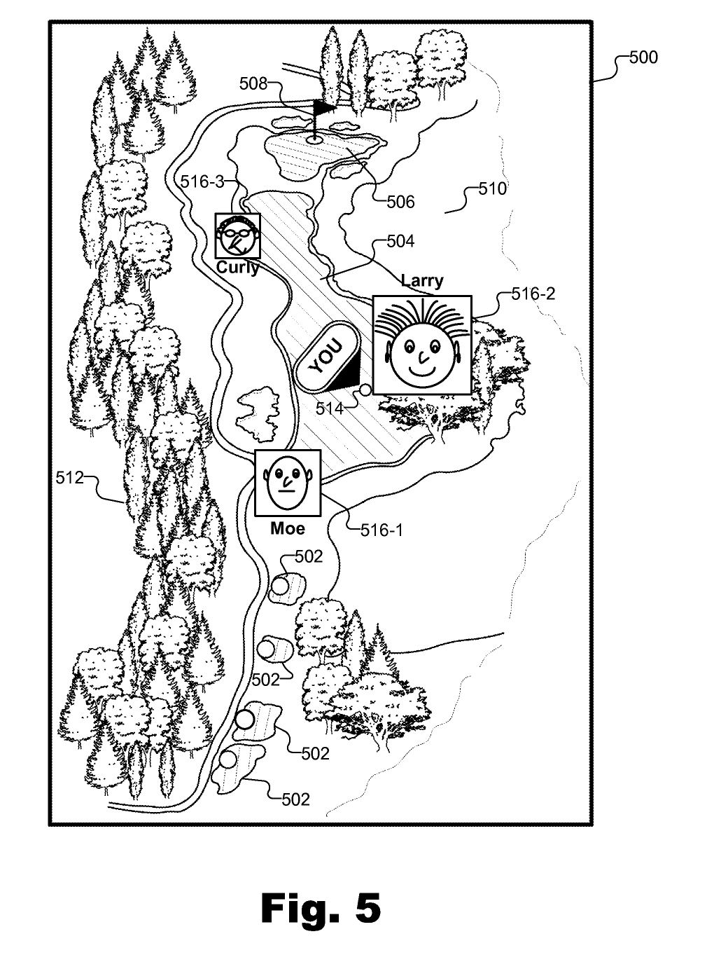

FIG. 5 illustrates an exemplary GUI 500 that may be provided for display by a mobile device associated with a golfer. As shown, GUI 500 may include a graphical representation of a map of a golf hole that the golfer is playing. For example, GUI 500 may include a graphical representation of one or more tee boxes 502, a fairway 504, a putting green 506, a golf pin 508, a water hazard 510, an out-of-bounds area 512, and/or any other geographic feature of a golf hole as may serve a particular implementation. The golfer may selectively zoom in on different portions of the golf hole as may serve a particular implementation.

As shown in FIG. 5, a graphical object 514 representative of a current geographic location of the mobile device associated with (e.g., carried by) the golfer may be displayed within GUI 500. Graphical object 514 may be overlaid on the graphical representation of the map, for example, and may be configured to track a position of the golfer as the golfer moves between successive strokes. In some examples, graphical object 514 may be selected by the golfer to access interactive golf content associated with the golfer. For example, graphical object 514 may be selected to access scoring information associated with the golfer, golf club selection information associated with the golfer, information associated with one or more previous times that the golfer has played the golf hole, and/or any other information associated with the golfer as may serve a particular implementation.

As shown in FIG. 5, one or more interactive golf content instances associated with one or more golfers who played the golf hole prior to the playing of the golf hole by the golfer may be provided for display within GUI 500. For example, interactive golf content instances 516-1 through 516-3 (collectively referred to herein as “interactive golf content instances 516”) are displayed within GUI 500. Each interactive golf content instance 516 may have a geotagged location and be displayed at a position within GUI 500 that corresponds to its geotagged location. In the example of FIG. 5, each interactive golf content instance 516 includes a picture of a golfer who has played the golf hole. However, it will be recognized that one or more other types of interactive golf content instances may be displayed within GUI 500 as may serve a particular implementation.

Each interactive golf content instance 516 may be selected for display in accordance with a detected geographic location of the mobile device of the golfer and/or in accordance with any other factor(s) as may serve a particular implementation. To illustrate, graphical object 514 may be representative of a detected geographic location of the mobile device after the golfer has hit a tee shot and moved to a current lie of the golf ball. Interactive golf content management facility 106 may compare the geographic location of the mobile device to geotagged locations of a plurality of interactive golf content instances to select one or more of the interactive golf content instances for display within GUI 500. For example, the selected interactive golf content instances 516 may all have geotagged locations within a predetermined distance of the detected geographic location of the mobile device, be associated with one or more golfers socially connected to the golfer (e.g., golfers designated by the golfer as friends of the golfer, professional golfers, etc.), be associated with a particular stroke (e.g., a tee shot), and/or have any other characteristic specified by the golfer and/or deemed relevant by interactive golf content management facility 106.

In the example of FIG. 5, interactive golf content instances 516 are each positioned within GUI 500 at a location representative of a lie of golfers named “Moe”, “Larry”, and “Curly” after their respective tee shots. In this manner, the golfer may compare his or her lie to the lie of other golfers who previously played the golf hole. The other golfers may be friends of the golfer, professional golfers, and/or any other golfer as specified by the golfer and/or interactive golf content management facility 106.

In some examples, a display size of each of interactive golf content instances 516 may be based on a relative proximity of their respective geotagged locations to the detected geographic location represented by graphical object 514. For example, as shown in FIG. 5, interactive golf content instance 516-2 may have a relatively larger display size than interactive golf content instances 516-1 and 516-3 because interactive golf content instance 516-2 is closest to the current geographic location of the mobile device of the golfer. The relative display sizes of interactive golf content instances 516 may be adjusted as the detected geographic location of the mobile device associated with the golfer changes.

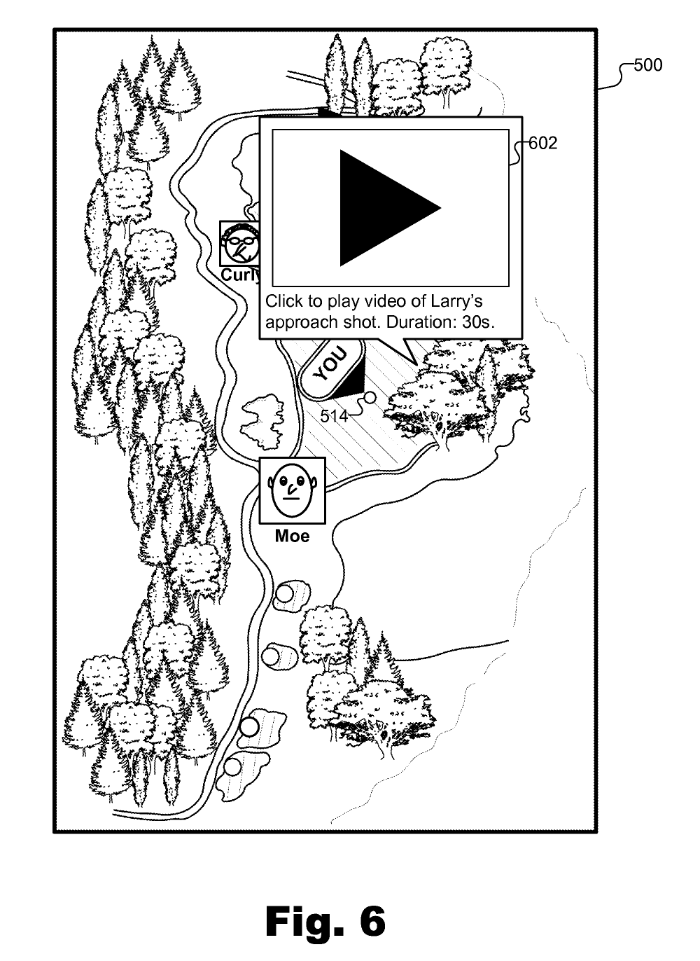

In some examples, an interactive golf content instance 516 associated with a golfer displayed within GUI 500 may be selected to access additional interactive golf content associated with the golfer. For example, FIG. 6 shows GUI 500 after interactive golf content instance 516-2 associated with the golfer named “Larry” has been selected. As shown in FIG. 6, in response to the selection of interactive golf content instance 516-2, video content 602 may be displayed within GUI 500. Video content 602 may show a golf shot taken by the golfer named “Larry” at the geographic location represented by the position of interactive golf content instance 516-2. In this manner, a golfer may see how someone else with a similar lie hits his or her shot. Video content 602 may be acquired and geotagged in any of the ways described herein.

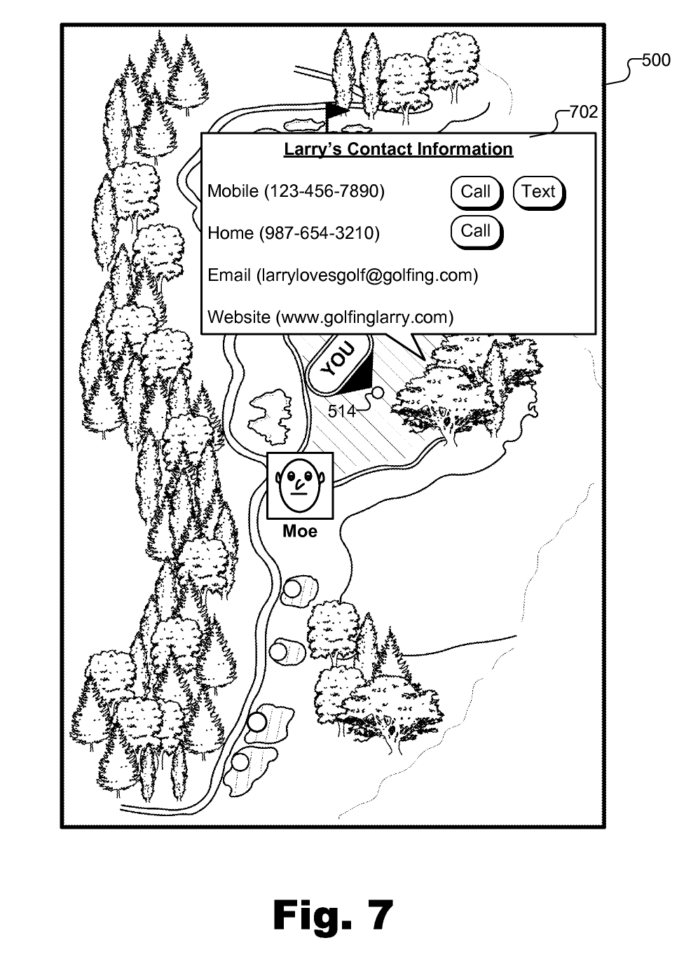

FIG. 7 illustrates additional or alternative interactive golf content that may be displayed in response to selection of interactive golf content instance 516-2. As shown in FIG. 7, the interactive golf content may include contact information 702 associated with the golfer named “Larry” that may be used by the golfer associated with the mobile device to communicate with the golfer named “Larry.” Contact information 702 may include one or more phone numbers, email addresses, websites, and/or other contact data associated with the golfer named “Larry” as may serve a particular implementation. In this manner, the golfer associated with the mobile device may utilize the mobile device to solicit advice, congratulate someone on a well-played shot, trash talk, and/or otherwise communicate with one or more other golfers who played the golf hole.

Video content 602 and contact information 702 are merely illustrative of the many different examples of additional interactive golf content that may be accessed by selecting one or more of interactive golf content instances 516 displayed within GUI 500 of FIG. 5.

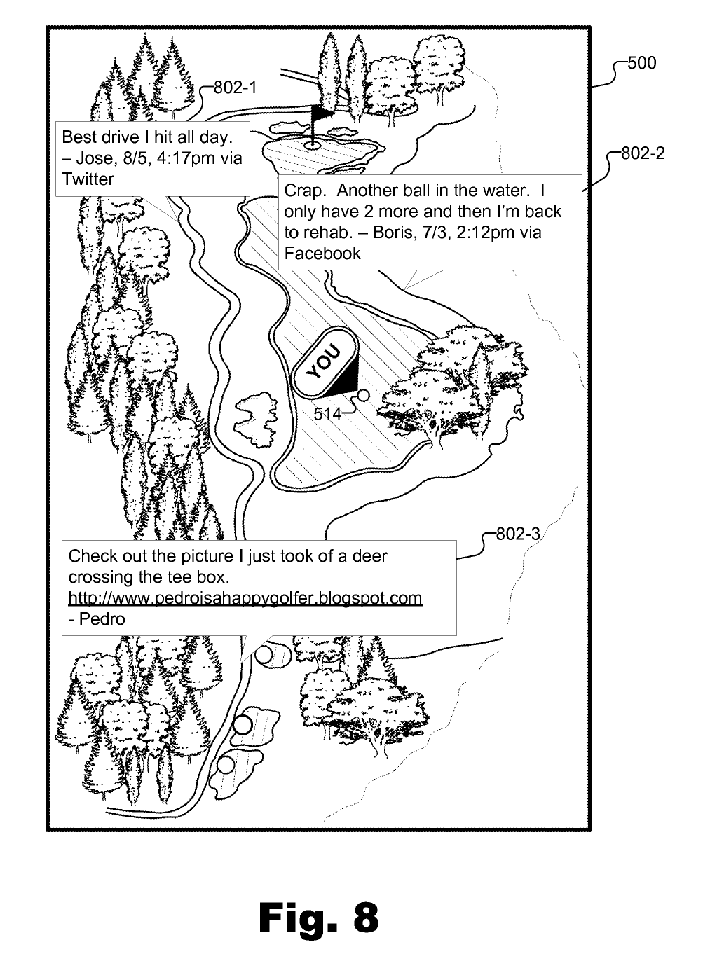

In some examples, one or more interactive golf content instances displayed within GUI 500 may include geotagged social networking content provided by one or more golfers. To illustrate, FIG. 8 shows GUI 500 having various geotagged social networking content instances 802-1 through 802-3 (collectively referred to herein as “social networking content instances 802) displayed therein. As shown in FIG. 8, social networking content instance 802-1 includes a Twitter update provided by a golfer named “Jose,” social networking content instance 802-2 includes a Facebook post provided by a golfer named “Boris”, and social networking content instance 802-3 includes a link to a blog post provided by a golfer named “Pedro.” One or more of social networking content instances 802 may be selected by a golfer to access additional social networking content and/or other types of interactive golf content as may serve a particular implementation.

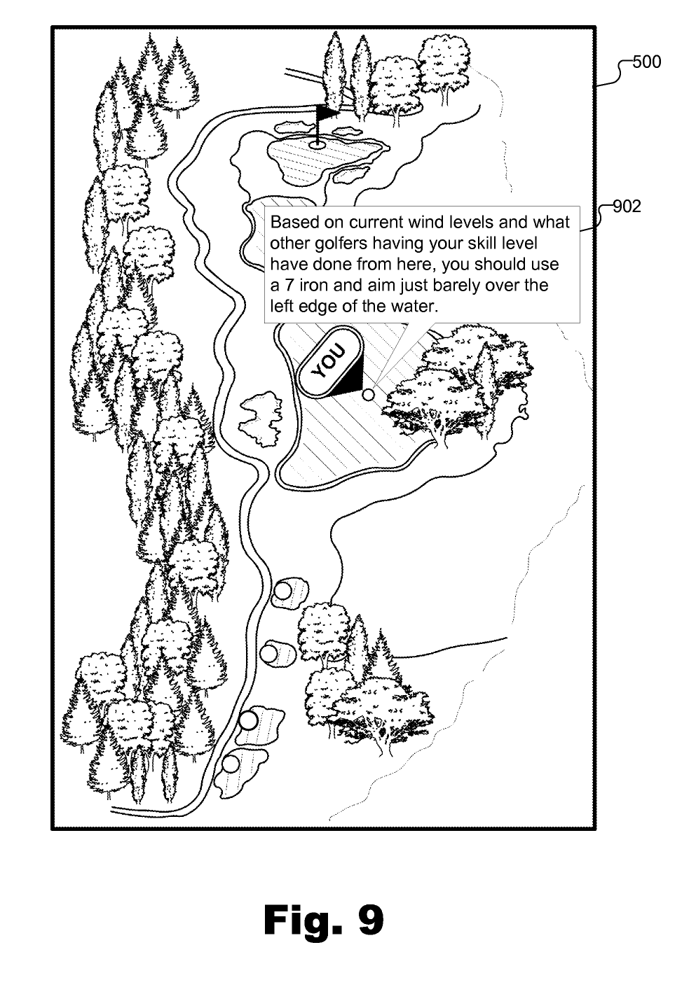

As mentioned, advice for the golfer associated with the mobile device may be automatically generated by interactive golf content management facility 106 for presentation by the mobile device. The advice may be based on a current geographic location of the golfer, past performance of the golfer and/or one or more other golfers, a user profile of the golfer, current weather information, and/or any other factor as may serve a particular implementation. To illustrate, FIG. 9 shows GUI 500 with advice 902 displayed therein. As shown, advice 902 may advise the golfer to use a particular golf club, aim in a particular direction, and/or otherwise hit a shot. Advice 902 is in part based on a skill level of the golfer. The skill level may be determined in accordance with input provided by the golfer, information included in a user profile associated with golfer, and/or automatically determined based on a past history of the golfer.

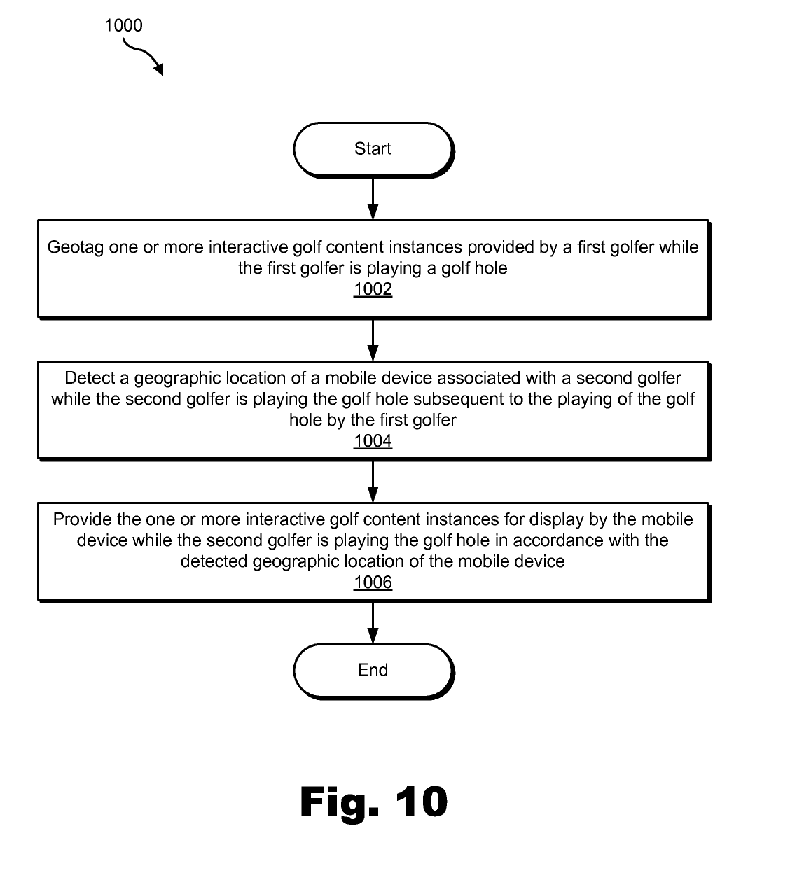

FIG. 10 illustrates another exemplary method 1000 of providing location-based interactive golf content for display by a mobile device associated with a golfer. While FIG. 10 illustrates exemplary steps according to one embodiment, other embodiments may omit, add to, reorder, and/or modify any of the steps shown in FIG. 10. The steps shown in FIG. 10 may be performed by any component or combination of components of system 100, interactive golf content management subsystem 202, mobile device 204, and/or interactive golf content application server 302 as may serve a particular implementation.

In step 1002, one or more interactive golf content instances provided by a first golfer while the first golfer is playing a golf hole are geotagged. Step 1002 may be performed in any of the ways described herein.

In step 1004, a geographic location of a mobile device associated with a second golfer is detected while the second golfer is playing the golf hole subsequent to the playing of the golf hole by the first golfer. Step 1004 may be performed in any of the ways described herein.

In step 1006, the one or more interactive golf content instances are provided for display by the mobile device while the second golfer is playing the golf hole in accordance with the detected geographic location of the mobile device. Step 1006 may be performed in any of the ways described herein.

In certain embodiments, one or more of the components and/or processes described herein may be implemented and/or performed by one or more appropriately configured computing devices. To this end, one or more of the systems and/or components described above may include or be implemented by any computer hardware and/or computer-implemented instructions (e.g., software) embodied on a non-transitory computer-readable medium configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions executable by one or more computing devices. In general, a processor (e.g., a microprocessor) receives instructions, from a tangible computer-readable medium, (e.g., a memory, etc.), and executes those instructions, thereby performing one or more processes, including one or more of the processes described herein. Such instructions may be stored and/or transmitted using any of a variety of known non-transitory computer-readable media.

A non-transitory computer-readable medium (also referred to as a processor-readable medium) includes any non-transitory medium that participates in providing data (e.g., instructions) that may be read by a computer (e.g., by a processor of a computer). Such a non-transitory medium may take many forms, including, but not limited to, non-volatile media and/or volatile media. Non-volatile media may include, for example, optical or magnetic disks and other persistent memory. Volatile media may include, for example, dynamic random access memory (“DRAM”), which typically constitutes a main memory. Common forms of non-transitory computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other non-transitory medium from which a computer can read.

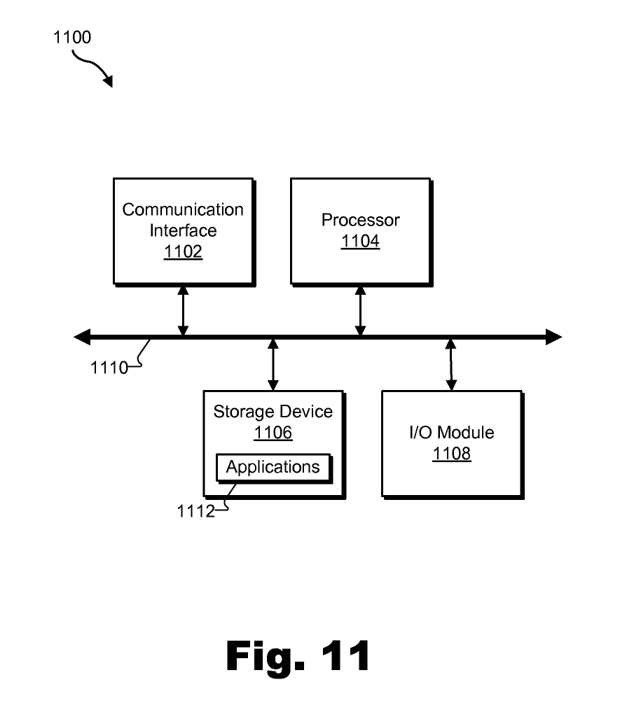

FIG. 11 illustrates an exemplary computing device 1100 that may be configured to perform one or more of the processes described herein. As shown in FIG. 11, computing device 1100 may include a communication interface 1102, a processor 1104, a storage device 1106, and an input/output (“I/O”) module 1108 communicatively connected via a communication infrastructure 1110. While an exemplary computing device 1100 is shown in FIG. 11, the components illustrated in FIG. 11 are not intended to be limiting. Additional or alternative components may be used in other embodiments. Components of computing device 1100 shown in FIG. 11 will now be described in additional detail.

Communication interface 1102 may be configured to communicate with one or more computing devices. Examples of communication interface 1102 include, without limitation, a wired network interface (such as a network interface card), a wireless network interface (such as a wireless network interface card), a modem, and any other suitable interface. Communication interface 1102 may additionally or alternatively provide such a connection through, for example, a local area network (such as an Ethernet network), a personal area network, a telephone or cable network, a satellite data connection, a dedicated URL, or any other suitable connection. Communication interface 1102 may be configured to interface with any suitable communication media, protocols, and formats, including any of those mentioned above.

Processor 1104 generally represents any type or form of processing unit capable of processing data or interpreting, executing, and/or directing execution of one or more of the instructions, processes, and/or operations described herein. Processor 1104 may direct execution of operations in accordance with one or more applications 1112 or other computer-executable instructions such as may be stored in storage device 1106 or another non-transitory computer-readable medium.

Storage device 1106 may include one or more data storage media, devices, or configurations and may employ any type, form, and combination of data storage media and/or device. For example, storage device 1106 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1106. For example, data representative of one or more executable applications 1112 (which may include, but are not limited to, one or more of the software applications described herein) configured to direct processor 1104 to perform any of the operations described herein may be stored within storage device 1106. In some examples, data may be arranged in one or more databases residing within storage device 1106.

I/O module 1108 may be configured to receive golfer input and provide golfer output and may include any hardware, firmware, software, or combination thereof supportive of input and output capabilities. For example, I/O module 1108 may include hardware and/or software for capturing golfer input, including, but not limited to, a keyboard or keypad, a touch screen component (e.g., touch screen display), a receiver (e.g., an RF or infrared receiver), and/or one or more input buttons.

I/O module 1108 may include one or more devices for presenting output to a golfer, including, but not limited to, a graphics engine, a display (e.g., a display screen, one or more output drivers (e.g., display drivers), one or more audio speakers, and one or more audio drivers. In certain embodiments, I/O module 1108 is configured to provide graphical data to a display for presentation to a golfer. The graphical data may be representative of one or more graphical user interfaces and/or any other graphical content as may serve a particular implementation.

In some examples, any of the facilities described herein may be implemented by or within one or more components of computing device 1100. For example, one or more applications 1112 residing within storage device 1106 may be configured to direct processor 1104 to perform one or more processes or functions associated with location tracking facility 102, user interface facility 104, and/or interactive golf content management facility 106. Likewise, storage facility 108 may be implemented by or within storage device 1106.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
detecting, by an interactive golf content computing system, a geographic location of a mobile device associated with a golfer while the golfer is playing a golf hole;
selecting, by the interactive golf content computing system, interactive golf content associated with one or more other golfers who played the golf hole previous to the playing of the golf hole by the golfer in accordance with the detected geographic location; and
providing, by the interactive golf content computing system, the selected interactive golf content for display by the mobile device.

2. The method of claim 1, further comprising:
providing, by the interactive golf content computing system, a map of the golf hole for display by the mobile device;
wherein the selected interactive golf content is configured to be overlaid on the map when displayed by the mobile device.

3. The method of claim 1, further comprising:
detecting, by the interactive golf content computing system, an updated geographic location of the mobile device in response to a movement by the golfer to another position while playing the golf hole;
selecting, by the interactive golf content computing system, updated interactive golf content associated with the one or more other golfers in accordance with the detected updated geographic location; and
providing, by the interactive golf content computing system, the selected updated interactive golf content for display by the mobile device.

4. The method of claim 1, further comprising:
determining, by the interactive golf content computing system, that the golfer is playing another golf hole;
detecting, by the interactive golf content computing system, another geographic location of the mobile device while the golfer is playing the another golf hole;
selecting, by the interactive golf content computing system, interactive golf content associated with one or more other golfers who played the another golf hole previous to the playing of the another golf hole by the golfer in accordance with the detected another geographic location; and
providing, by the interactive golf content computing system, the selected interactive golf content associated with the one other more other golfers who played the another golf hole previous to the playing of the another golf hole by the golfer for display by the mobile device.

5. The method of claim 1, wherein the selecting of the interactive golf content comprises:
analyzing a geotagged location corresponding to each of a plurality of interactive golf content instances; and
selecting, based on the analyzing, one or more of the plurality of interactive golf content instances having a corresponding geotagged location located within a predetermined distance of the detected geographic location of the mobile device to be included in the selected interactive golf content.

6. The method of claim 1, wherein the selected interactive golf content comprises a plurality of interactive golf content instances each having a corresponding geotagged location, and wherein the method further comprises:
designating, by the interactive golf content computing system, a display size of each of the plurality of interactive golf content instances based on a relative proximity of the geotagged location of each of the interactive golf content instances to the detected geographic location of the mobile device.

7. The method of claim 6, wherein the plurality of interactive golf content instances comprises at least a first interactive golf content instance having a first geotagged location and a second interactive golf content instance having a second geotagged location relatively farther away from the detected geographic location of the mobile device than the first geotagged location, and wherein the designating comprises designating the first interactive golf content instance to have a larger display size than the second interactive golf content instance.

8. The method of claim 1, wherein the one or more other golfers comprise one or more golfers indicated by the golfer as being friends of the golfer.

9. The method of claim 1, wherein the one or more other golfers comprise at least one professional golfer.

10. The method of claim 1, wherein the interactive golf content comprises at least one of geotagged social networking content provided by the one or more other golfers, scoring information associated with the one other more other golfers, multimedia content associated with the one or more other golfers, lie information associated with the one or more other golfers, golf club selection information associated with the one or more other golfers, a picture of the one or more other golfers, and contact information associated with the one or more other golfers.

11. The method of claim 1, wherein the interactive golf content is further associated with the golf hole that the golfer is playing.

12. The method of claim 1, wherein the selecting of the interactive golf content comprises selecting one or more interactive golf content instances having a timestamp included within a predetermined timeframe.

13. The method of claim 1, further comprising providing, by the interactive golf content computing system, weather information associated with the detected geographic location for display by the mobile device.

14. The method of claim 1, further comprising automatically generating, by the interactive golf content computing system for presentation by the mobile device, advice for the golfer based on the selected interactive golf content.

15. The method of claim 1, further comprising facilitating, by the interactive golf content computing system, input by the golfer of interactive golf content associated with the golfer while the golfer is playing the golf hole.

16. The method of claim 15, further comprising providing, by the interactive golf content computing system, the interactive golf content associated with the golfer for display by one or more other mobile devices associated with one or more other golfers playing the golf hole.

17. The method of claim 1, embodied as computer-executable instructions on at least one non-transitory computer-readable medium.

18. A method comprising:
geotagging, by an interactive golf content computing system, one or more interactive golf content instances provided by a first golfer while the first golfer is playing a golf hole;
detecting, by the interactive golf content computing system, a geographic location of a mobile device associated with a second golfer while the second golfer is playing the golf hole subsequent to the playing of the golf hole by the first golfer; and
providing, by the interactive golf content computing system for display by the mobile device, the one or more interactive golf content instances while the second golfer is playing the golf hole in accordance with the detected geographic location of the mobile device.

19. The method of claim 18, further comprising:
providing, by the interactive golf content computing system, a map of the golf hole for display by the mobile device;
wherein the one or more interactive golf content instances are configured to be overlaid on the map when displayed by the mobile device.

20. The method of claim 18, embodied as computer-executable instructions on at least one non-transitory computer-readable medium.

21. A system comprising:
a location tracking facility configured to detect a geographic location of a mobile device associated with a golfer while the golfer is playing a golf hole; and
an interactive golf content management facility communicatively coupled to the location tracking facility and configured to
select interactive golf content associated with one or more other golfers who played the golf hole previous to the playing of the golf hole by the golfer in accordance with the detected geographic location, and
provide the selected interactive golf content for display by the mobile device.

22. The system of claim 21, wherein the interactive golf content management facility is further configured to:
provide a map of the golf hole for display by the mobile device;
wherein the selected interactive golf content is configured to be overlaid on the map when displayed by the mobile device.

23. The system of claim 21, wherein the interactive golf content management facility is configured to select the interactive golf content by:
analyzing a geotagged location corresponding to each of a plurality of interactive golf content instances; and
selecting, based on the analyzing, one or more of the plurality of interactive golf content instances having a corresponding geotagged location located within a predetermined distance of the detected geographic location of the mobile device to be included in the selected interactive golf content.

24. The system of claim 21, wherein the selected interactive golf content comprises a plurality of interactive golf content instances each having a corresponding geotagged location, and wherein the interactive golf content management facility is further configured to designate a display size of each of the plurality of interactive golf content instances based on a relative proximity of the geotagged location of each of the interactive golf content instances to the detected geographic location of the mobile device.
